(19) United States
(12) Patent Application Publication
(10) Pub. No.: US 2010/0209063 A1
(43) Pub. Date: Aug. 19, 2010

(54) PATCH PANEL SYSTEM

(75) Inventors: Yoshinori Hoshino, Kawasaki (JP); Hideo Araki, Kawasaki (JP); Hiroshi Katagiri, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/702,558

(22) Filed: Feb. 9, 2010

(30) Foreign Application Priority Data
Feb. 13, 2009 (JP) 2009-031982

(51) Int. Cl. G02B 6/00

(52) U.S. Cl. 385/135

(57) ABSTRACT

A patch panel system includes a base panel having an array of openings and an array of engageable portions provided adjacent to the openings, and a first panel having a first opening and a first engageable portion which is arranged to be cooperatively engageable with the corresponding one of the engageable portions of the base panel, the first opening being configured to accommodate a first adapter, the corresponding of the openings in the base panel being configured to receive the first adapter therein.

### CROSS-REFERENCE TO RELATED APPLICATION

This application is based upon and claims the benefit of priority of the prior Japanese Patent Application No. 2009-31982, filed on Feb. 13, 2009, the entire contents of which are incorporated herein by reference.

### FIELD

The embodiments discussed herein are related to a patch panel system.

### BACKGROUND

Many patch panel systems exist today and used in various electronics equipment application, such as telecommunications, data transmission, networking and the like, for providing connections between transmission media such as optical fiber cables. Typically, a patch panel system includes a panel plate having an array of openings therein. An adapter is mounted in each of the openings and adapted to hold a component such as a connector of an optical fiber cable. As is known, there are several different types of connectors having different shapes and also several different types of adapters for the corresponding type of connectors. It is therefore desired to provide a patch panel system which may include any of several different types of adapters with simple design and construction and which is easy to change the configuration of adapters. See, for example, Japanese Laid-open Patent Publication No. 06-36831 and Japanese Laid-open Patent Publication No. 2000-314828.

### SUMMARY

According to an aspect of the invention, a patch panel system includes a base panel having an array of openings and an array of engageable portions provided adjacent to the openings, and a first panel having a first opening and a first engageable portion which is arranged to be cooperatively engageable with the corresponding one of the engageable portions of the base panel, the first opening being configured to accommodate a first adapter, the corresponding of the openings in the base panel being configured to receive the first adapter therein.

The object and advantages, of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is a perspective view of a base panel and FIGS. 1B and 1C are front and rear perspective views of an individual panel.

FIGS. 2A and 2B are perspective views which depict two different types of adapters respectively.

FIGS. 3A to 3C are perspective views of assembling a patch panel.

FIGS. 4A to 4D are perspective views which depict the other arrangements between various adapters and various individual panels.

FIGS. 5A and 5B are top views which depict two types of individual panels having different thickness respectively.

FIG. 6 is a perspective view of a patch panel system.

FIG. 7 is a perspective view of another patch panel system.

FIGS. 8A to 8C are perspective views which depict the other engagements between the base panel and the individual panels respectively.

FIG. 9 is a perspective view of the other patch panel system.

### DESCRIPTION OF EMBODIMENTS

Preferred embodiments of the present invention will be explained with reference to accompanying drawings.

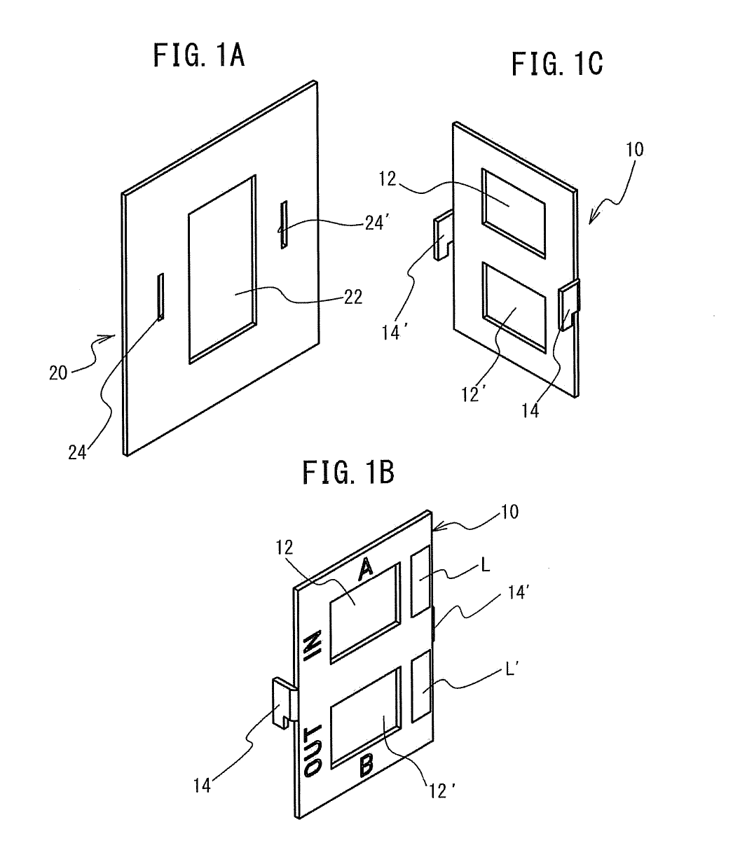

FIG. 1A is a perspective view of a portion of a base panel 20 and FIGS. 1B and 1C are front and rear perspective views of an individual panel 10. The base panel 20 and the individual panel 10 constitute a patch panel which is described later and which may be used for a plurality of different connective arrangements in communication devices.

The individual panel 10 and the base panel 20 are formed into a plate shape as shown in FIGS. 1A to 1C and may be made of a material such as plastic or metal. The individual panel 10 has rectangular openings 12 and 12′ formed in the upper half and the lower half thereof respectively. The adapters (not shown in the figure) are secured to the individual panel 10 after the adapter has been inserted into the openings 12 and 12′. The individual panel 10 further has a pair of latching hooks 14 and 14′ at the both sides thereof. The latching hooks 14 and 14′ extend backward and their end portions extend downward for the engagement with the base panel 20.

The base panel 20 has a rectangular opening 22. The opening 22 is configured to dispose therein any adapter which is secured to the individual panel 10. The base panel 20 further has a pair of slots 24 and 24′ for the engagement with the pair of latching hooks 14 and 14′. The slots 24 and 24′ are narrow openings and extend in a vertical direction. The latching hooks 14 and 14′ of the individual panel 10 are engaged with the slots 24 and 24′ after the latching hooks 14 and 14′ has been inserted into the slots 24 and 24′.

As shown in FIG. 1B, some characters or some symbols are put on the front surface of the individual panel 10 to distinguish two openings 12 and 12′. Moreover, labels L and L′ are put adjacent to the openings 12 and 12′ respectively. The characters and labels put on the individual panel 10 will be omitted in the other figurers.

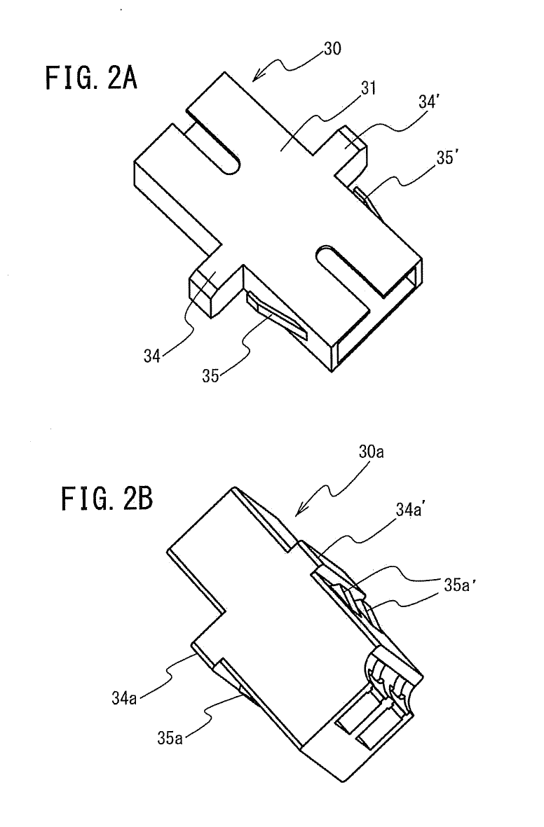

FIGS. 2A and 2B are perspective views which depict a first type adapter 30 and a second type adapter 30a. The first and second type adapters 30 and 30a have mutually different shapes. In FIG. 2A, the first type adapter 30 has a main body 31, a pair of flanges 34 and 34′ and a pair of resilient detents 35 and 35′. The flanges 34 and 34′ are formed on the both side walls of the main body 31. The resilient detents 35 and 35′ are provided on the both side walls of the main body 31. The main body 31 and the flanges 34 and 34′ are made of plastic. The resilient detents 35 and 35′ are made of metal. The first type adapter 30 is configured to provide connection between two optical fiber cables having first type connectors at the end thereof, by holding the first type connectors within the main body 31.

The second type adapter 30a has a main body 31a, a pair of flanges 34a and 34a′ and four detents 35a and 35a′. These of the main body 31a, the flanges 34a and 34a′ and the detents 35a and 35a′ are formed in a one-piece construction and made of plastic. The second type adapter 30a is adapted to hold, within the main body 31a, a second type connector having a different shape from the first type connector. The different types of adapters 30 and 30a are adapted to hold therein the corresponding types of connectors respectively.

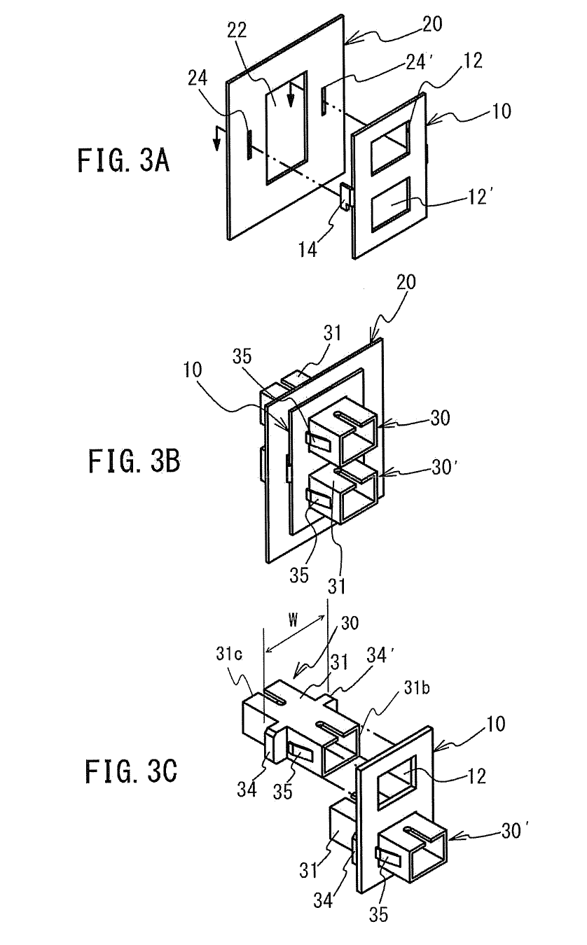

FIG. 3A is a perspective view of the base panel 20 and the individual panel 10 which becomes engaged with the base panel 20. FIG. 3B is a perspective view of a portion of a patch panel with the adapters 30 and 30′ secured thereto. FIG. 3C is a perspective view of the individual panel 10 and the adapter 30 which becomes secured to the individual panel 10. In FIG. 3C, the base panel 20 is omitted for clarity.

After the latching hooks 14 and 14′ have been inserted into the slots 24 and 24′ respectively, the latching hooks 14 and 14′, particularly the end portions of extending downward, are engaged with the slots 24 and 24′. The individual panel 10 maintains the engagement with the base panel 20 by its own weight. The adapters 30 and 30′ are secured to the openings 12 and 12′ after the individual panel 10 has been engaged with the base panel 20 and then the adapters 30 and 30′ have been inserted into both of the opening 22 of the base panel 20 and the openings 12 and 12′.

After the adapters 30 and 30′ are secured to the individual panel 10 and the base panel 20, the engagement between the individual panel 10 and the base panel 20 becomes steadier due to own weight increased by the adapters 30 and 30′. Further, after optical fiber cables are connected to the adapters 30 and 30′, the engagement become much steadier due to own weigh further increased by the cables and then it prevents the disengagement between the latching hooks 14 and 14′ and the slot 24 and 24′.

As shown in FIG. 3C, the main body 31 of the adapter 30 has a leading edge 31b on a side near the resilient detents 35 and a trailing edge 31c on a side away from the resilient detents 35. The leading edge 31b of the adapter 30 is inserted into the opening 22 of the base plate 20 (not shown in FIG. 3C) and the opening 12 of the individual panel 10. In FIG. 3C, the base panel is omitted for clarity. When the resilient detents 35 and 35′ passes the opening 12, the resilient detents 35 and 35′ elasticity bend inward by contacting the edge of the opening 12. When the resilient detents 35 and 35′ passes the opening 12, the individual panel 10 and the base panel 20 (not shown in FIG. 3C) are placed between the flanges 34 and 34′ and the resilient detents 35 and 35′. The width W of the flanges 34 and 34′ as shown in FIG. 3C is longer the widths of the opening 12 of the individual panel 10 and the opening 22 of the base panel 20. That is, the flanges 34 and 34′ have the function to restrict the passage of the adapter 30. The main body 31 of the adapter 30 is secured to the opening 12 of the individual panel 10 by the individual panel 10 being placed between the flanges 34 and 34′ and the resilient detents 35 and 35′.

When the adapter 30 is detached from the individual panel 10, it can be detached by turning the resilient detents 35 and 35′ inward and then pulling the trailing edge 31c of the main body 31. When the individual panel 10 is detached from the base panel 20, it can be detached by, after the adapter 30 has been detached, lifting the individual panel 10 upward and then pulling the individual panel 20 forward.

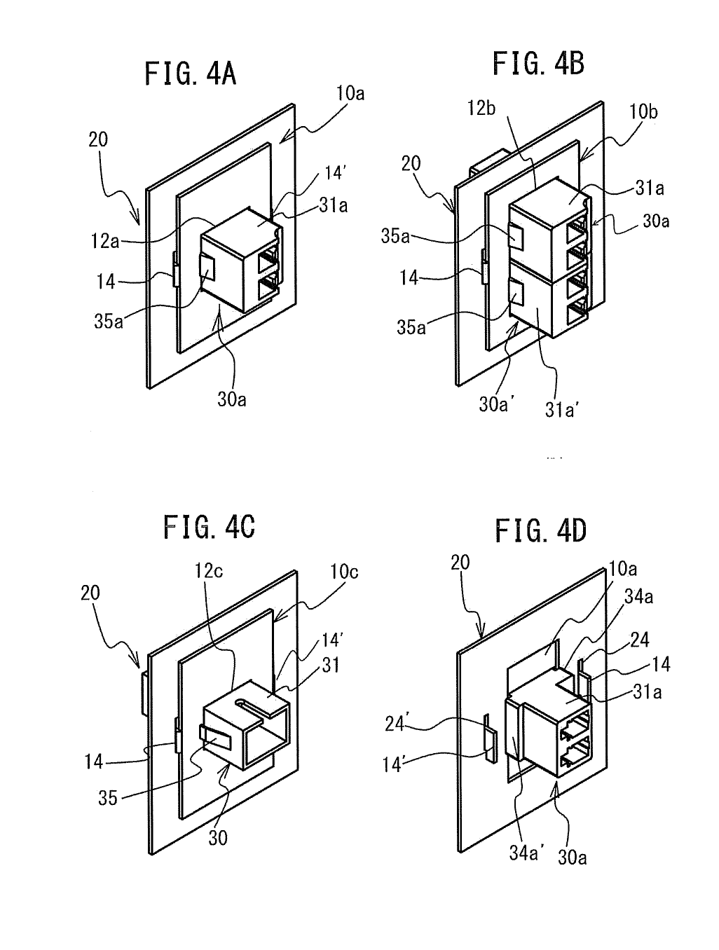

FIGS. 4A to 4D are perspective views which depict the other arrangements between various adapters and various individual panels. All of the base panels 20 shown in FIGS. 4A to 4D are the same one. All pairs of latching hooks 14 and 14′ shown in FIGS. 4A to 4D have the same configuration and therefore any pair of latching hooks 14 and 14′ are engageable with any one pair of slots 24 and 24′ of the base panel 20.

FIG. 4A depicts an arrangement between a second type individual panel 10a and a second type adapter 30a. The second type individual panel 10a has an opening 12a which is configured to accommodate the second type adapter 30a therein. Therefore, the adapter 30a is mountable to the base panel 20 by using the second individual panel 10a.

FIG. 4B depicts an arrangement between a third type individual panel 10b and a double of the second type adapters 30a and 30a′. The third type individual panel 10b has a single opening 12b which is configured to accommodate the double of the second type adapters 30a and 30a′. The double of the second type adapters 30a and 30a′ are mountable to the base panel 20 by using the third type individual panel 10b.

FIG. 4C depicts an arrangement between a fourth type individual panel 10c and a single first type adapter 30. An opening 12c of the fourth individual panel 10c is configured to accommodate the single first type adapter 30. The single first type adapter 30 is mountable to the base panel 20 by using the fourth type individual panel 12c. FIG. 4D is a rear perspective view of the arrangement of FIG. 4A.

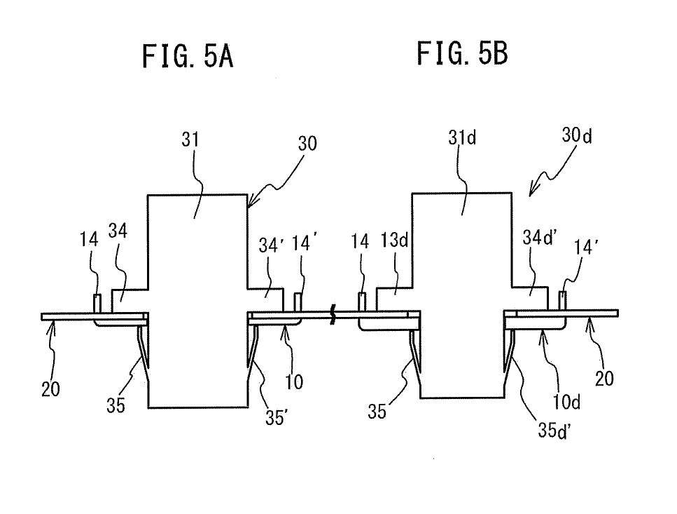

FIGS. 5A and 5B are top views which depict two types of individual panels 10 and 10d having different thickness respectively. After the adapter 30 is inserted into the opening 12 of the individual panel 10, the adapter 30 is locked with the flanges 34 and 34′ and the resilient detents 35 and 35′. Similarly, another adapter 30d having a different shape is locked with flanges 34d and 34d′ and resilient detents 35d and 35d′. The distance between the flange 34 and the detent resilient 35 of the adapter 30 is shorter than the distance between the flange 34d and the resilient detent 35d of the adapter 30d. Therefore, the thickness of the individual panel 30 is smaller than the thickness of the individual panel 10d. As shown in the FIG. 5A, a relatively thinner individual panel may be used when the distance between the flange and the detent is relatively shorter. Similarly, as shown in the FIG. 5B, a relatively thicker individual panel may be used when the distance between the flange and the detent is relatively longer.

If the thinner individual panel were applied for the adapter having the above-mentioned longer distance, the clearance between the resilient detent and the individual panel might become insufficiently grater and then the adapter might vibrate due to the insufficient grater clearance. However, the adapter can be prevented from the vibration by the adjusting the thickness of the individual panel according to the distance between the flange 34 and the resilient detent 35, such as by the use of the thickness different individual panels 10 and 10d.

Moreover, if the thicker individual panel were applied for the adapter having the above-mentioned shorter distance, it might become difficult for the resilient detent to pass the opening of the individual panel at the installation of the adapter. It might also become difficult to detach the adapter from the individual panel because the ends of the resilient detents come in contact with the individual panel and then it does not bend inward for the detachment of the adapter. However, by adjusting the thickness of the individual panel, the clearance between the flange and the resilient detent can be sufficiently adjusted and then it can be easy to install and detach the adapter into and from the individual panel.

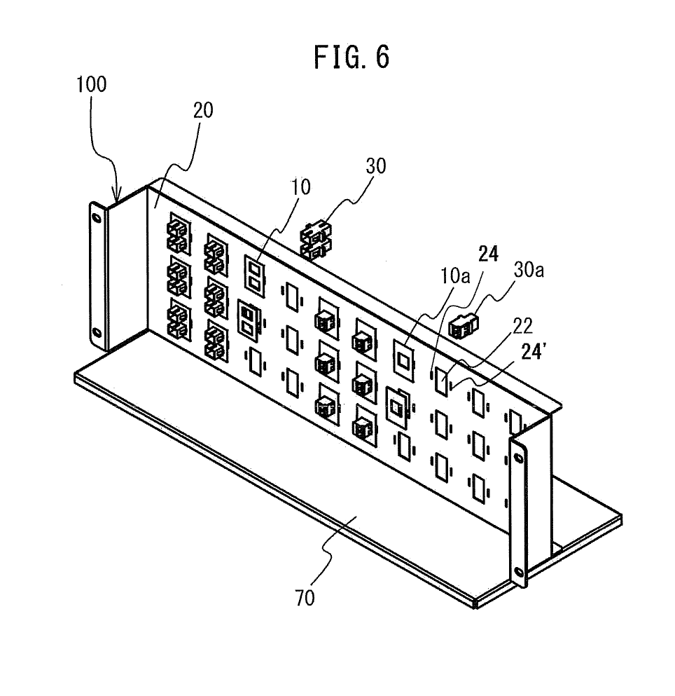

FIG. 6 is a perspective view of a patch panel system 100. The patch panel system 100 includes a base panel 20, a plurality of first type individual panels 10, a plurality of second type individual panels 10a and a support plate 70. The patch panel system 100 may be used for a rack-mountable communication device. The base panel 20, the first type individual panels 10 and the second type individual panels 10a may be provided as a kit or a patch panel after they have been assembled.

The base panel 20 and the support plate 70 are made of metal and formed in a plate shape. The base panel 20 has an array of openings 22 and an array of pairs of slots 24 and 24′. The openings 22 are configured to disposed several types of adapters therein. The first type individual panel 10 has two openings to accommodate the first type adapters 30 therein. The second type individual panel 10a has an opening to accommodate the second type adapter 30a. The first and second type individual panels 10 and 10a have pairs of latching hooks 14 and 14′ as shown in FIG. 3A, any pair of latching hooks 14 and 14′ can be engageable to any pairs of slots 24 and 24′. A plurality of the first and second type individual panels 10 and 10a are engaged with the base panel 20 and a plurality of the first and second type adapters 30 and 30a are secured to the patch panel system 100.

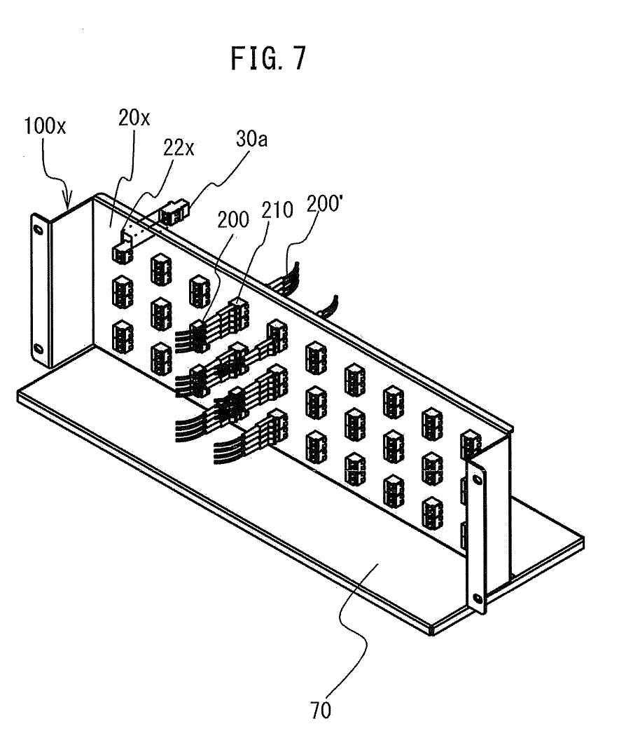

FIG. 7 is a perspective view of another patch panel system 100x. The patch system 100x has a panel plate 20x and a support plate 70. The panel plate 20x has an array of openings 22x which are configured to accommodate a single type of adapters 30a. Each of the adapters 30a has the same shape and each two adapters 30 are directly secured to each of the openings 22 of the panel plate 20x. The adapter 30a connects between optical fiber cables 200 and 200′ by holding connectors provided the end of the cables within the adapter 30a. In this patch panel system 100x, the other types of adapters can not be mountable. To mount the other types of adapters, it is necessary to redesign and reconstruct the whole of the panel plate 20x.

In the patch panel system 100 as shown in FIG. 6, the other types of adapters can be easily applied without replacing the whole of the panel plate, that is, by providing individual panels which match with the newly desired types of adapters. Moreover, the manufacturers can provide only a base panel and necessary individual panels corresponding to each type of adapters, the cost of manufacturing is controlled.

Moreover, the patch panel system 100 as shown in FIG. 6, each of the individual panels can be mountable on either one of the outer side and the inner side of the base panel 20. Therefore, it becomes easy to install and detach the individual panels 10 and 10a. Moreover, since the individual panels 10 and 10a can be easily mounted on the base panel 20, the adapters 30 and 3a can be installed on the patch panel system 100 without imposing complex work to the user. Moreover, the existing patch panel system can be easily replaced by having prepared the individual panels corresponding to the existing several types of adapters.

Moreover, when the adapters 30a used in the patch panel system 100 is detached, the detached adapters 30a may be used in the patch panel system 100x which is a system dedicated to the adapters 30a.

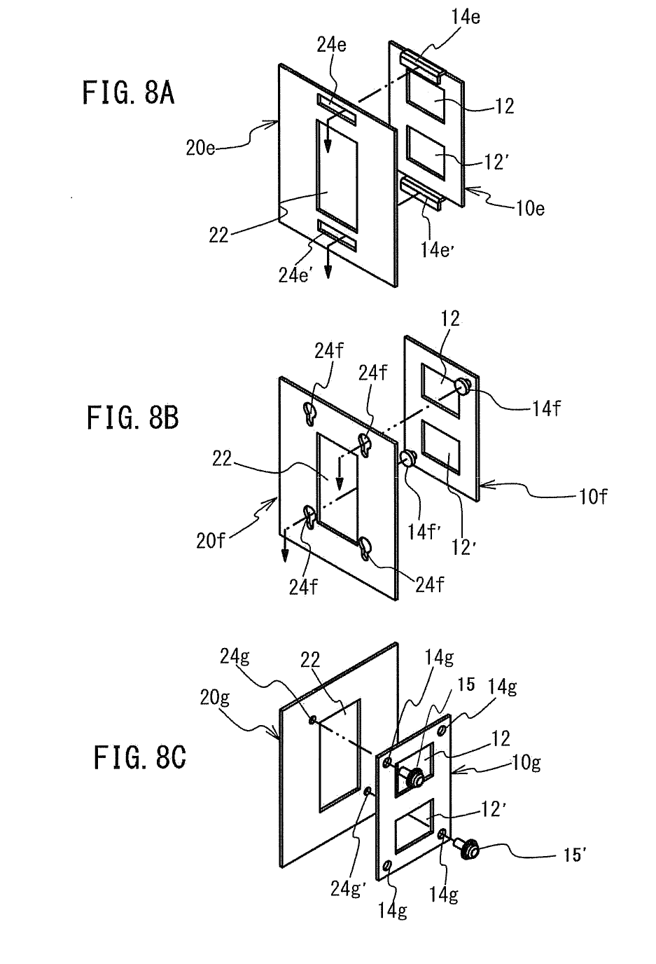

FIGS. 8A to 8C are perspective views which depict the other engagements between the base panel and the individual panels respectively. In FIG. 8A, an individual panel 10e has a pair of hooks 14e and 14e′ adjacent to the upper end lower ends thereof respectively. A base panel 22e has a pair of slots 24e and 24e′ adjacent to the upper and lower edge hereof respectively, which are engaged with the hooks 14e and 14′ respectively. The slots 24e and 24e′ are extending horizontally and the end portions of the hooks 14e and 14e′ are extending downward for providing the engagement by its own weight. These configurations also provide the easy engagement between the individual panel 10e and the base panel 20e.

In FIG. 8B, an individual panel 10f has two pins 14f and 14f′ at the diagonal corners thereof and a base panel 20f has four openings 24f at the four corners. Each of the openings 24f has a shape that becomes smaller from the upper side to the lower side, suitable to the engagement with the pins 14f and 14f′ and by its own weight. Since the openings 24f for the engagement are provided at the four corners, the individual panel 10f can be mountable on a front surface and a rear surface.

In FIG. 8C, an individual panel 10g has four openings 14g at the four corners. A base panel 20g has two screw holes 24g and 24g′ at the diagonal corners thereof. The engagement between the individual panel 10g and base panel 20g is provided with two screws 15 and 15′. The individual panel 10g can be also mountable on either one of a front surface and a rear surface.

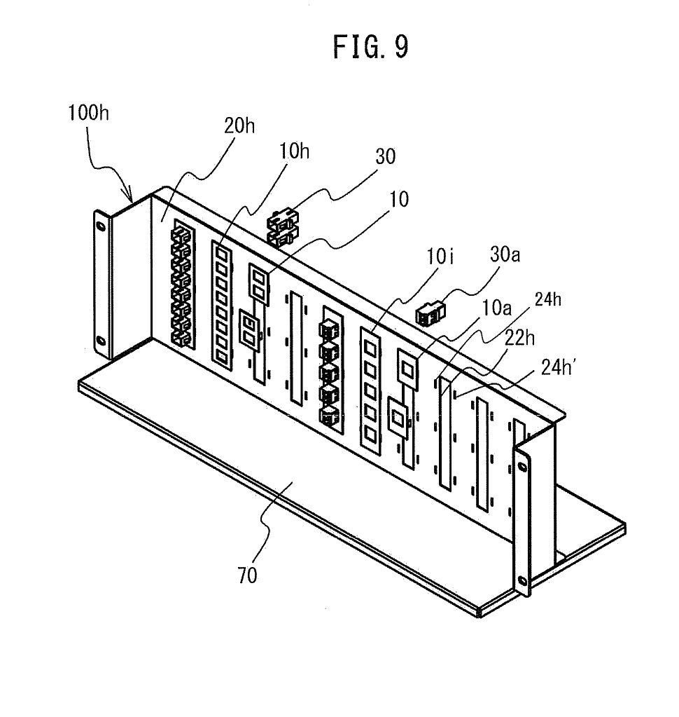

FIG. 9 is a perspective view of the other patch panel system 100h. The patch panel system 100h includes a base panel 20h, a plurality of types of individual panels 10, 10a, 10h and 10i and a support plate 70. The base panel 20 has an array of longitudinal openings 22h and an array of pairs of slots 24 and 24′. Each three pairs of slots 24h and 24h′ are provided for each of the longitudinal openings 22h. The individual panel 10h has eight openings which are adapted to accommodate the adapters 30 therein and the individual panel 10i has five openings which adapted to secure the other type connectors 30a therein.

Although patch panel systems for optical fiber connections has described as the example, this inventions can be applied to patch panel systems for the other transmission media.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A patch panel system comprising:
a base panel having an array of openings and an array of engageable portions provided adjacent to the openings; and
a first panel having a first opening and a first engageable portion which is arranged to be cooperatively engageable with the corresponding one of the engageable portions of the base panel, the first opening being configured to accommodate a first adapter, the corresponding of the openings in the base panel being configured to receive the first adapter therein.

2. The patch panel system according to claim 1, further comprising:
a second panel having a second opening and a second engageable portion which is arranged to be cooperatively engageable with the corresponding one of the engageable portions of the base panel, the second opening being configured to accommodate a second adapter having a different shape from the first adapter, the corresponding of the openings in the base panel being configured to receive the second adapter therein.

3. The patch panel system according to claim 1, wherein
the base panel has a first surface and a second surface and the first panel is mountable on one of the first surface and the second surface.

4. The patch panel system according to claim 1, wherein
the first panel has a plurality of first openings which configured to accommodate a plurality of first adapters, and
the corresponding one of the openings in the base panel is configured to receive the plurality of first adapters therein.

5. The patch panel system according to claim 1, wherein
the first adapter has a flange and a resilient detent and is configured to secure to the base panel and the first panel by placing the base panel and the first panel between the flange and the resilient detent, and
the thickness of the first panel is determined according to a distance between the flange and the resilient detent.

6. The patch panel system according to claim 1, further comprising:
a support plate mounting the base panel.

7. A patch panel comprising;
a base panel having an array of openings and an array of engageable portions provided adjacent to the openings;
first and second adapters having different shapes and adapted to hold a first and second connectors respectively;
a first, panel having a first opening and a first engageable portion which is engaged with the corresponding one of the engageable portions of the base panel, the first opening being configured to accommodate the first adapter therein; and
a second panel having a second opening and a second engageable portion which is engaged with the corresponding one of the engageable portions of the base panel, the second opening being configured to accommodate the second adapter therein;
wherein the openings of the base panel are configured to receive the first and second adapters therein.
